(19) United States
(12) Patent Application Publication
(10) Pub. No.: US 2017/0109684 A1
(43) Pub. Date: Apr. 20, 2017

(54) Assignment and Management of Tasks to Perform Wellsite Operations

(71) Applicant: Schlumberger Technology Corporation, Sugar Land, TX (US)

(72) Inventor: Cen Liu, Houston, TX (US)

(21) Appl. No.: 14/882,660

(22) Filed: Oct. 14, 2015

(51) Int. Cl. G06Q 10/06

(52) U.S. Cl. CPC G06Q 10/063114

(57) ABSTRACT

Methods and apparatus for communicating between a control center and a communication device, such as may be proximate field equipment on a job site. Such communication may include assigning a task for operating the field equipment at the control center, creating visual information demonstrating the task, and providing the visual information to the communication device. The visual information is displayed on the communication device, and visual content of operating parameters of the field equipment is created in response to the task and provided to the control center. Such communication may also include assigning an updated task for operating the field equipment in response to the visual content at the control center, creating updated visual information demonstrating the updated task, providing the updated visual information to the communication device, and displaying the updated visual information on the communication device.

### BACKGROUND OF THE DISCLOSURE

Operations performed at oilfield wellsites may include drilling, cementing, acidizing, water jet cutting, and hydraulic fracturing of subterranean formations, among other examples. Tasks are assigned to field personnel during the manufacture and/or installation of field equipment utilized during such oilfield operations, or even during the operations, to fulfill the aforementioned operations. A supervisor calls the job, and manages the field personnel physically separated and often poorly connected through radio communications. At times, assigning tasks remotely to the field personnel to perform such oilfield operations can be inefficient, especially for difficult tasks employing complex information shared between the supervisor and the field personnel.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a method of operating a communication system between a control center and a communication device proximate field equipment on a job site. The method includes assigning a task for operating the field equipment at the control center, creating visual information demonstrating the task, and providing the visual information to the communication device. The method also includes displaying the visual information on the communication device, creating visual content of operating parameters of the field equipment in response to the task, and providing the visual content to the control center. The method also includes assigning an updated task for operating the field equipment in response to the visual content at the control center, creating updated visual information demonstrating the updated task, providing the updated visual information to the communication device, and displaying the updated visual information on the communication device.

The present disclosure also introduces an apparatus operable to communicate with a communication device proximate field equipment on a job site. The apparatus includes a processor and a memory including computer program code. The processor, the memory, and the computer program code are collectively operable to cause the apparatus to assign a task for operating the field equipment, create visual information demonstrating the task, and provide the visual information to the communication device. The processor, the memory, and the computer program code are also collectively operable to cause the apparatus to receive visual content of operating parameters of the field equipment in response to the task, assign an updated task for operating the field equipment in response to the visual content, create updated visual information demonstrating the updated task, and provide the updated visual information to the communication device.

The present disclosure also introduces an apparatus proximate field equipment on a job site operable to communicate with a control center. The apparatus includes a processor and a memory including computer program code. The processor, the memory, and the computer program code are collectively operable to cause the apparatus to receive visual information for a task for operating the field equipment from the control center, display the visual information, and create visual content of operating parameters of the field equipment in response to the task. The processor, the memory, and the computer program code are also collectively operable to cause the apparatus to provide the visual content to the control center, receive updated visual information for an updated task in response to the visual content for operating the field equipment from the control center, and display the updated visual information.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of an additive system at an oilfield wellsite that provides an environment for a communication system according to one or more aspects of the present disclosure.

FIG. 2 is a system level view of at least a portion of an example implementation of a communication system according to one or more aspects of the present disclosure.

FIG. 3 is a screen shot of a display of a computer of control center of a communication system according to one or more aspects of the present disclosure.

FIG. 4 is a schematic view of at least a portion of an example implementation of an apparatus of a communication system according to one or more aspects of the present disclosure.

FIG. 5 is a flow-chart diagram of at least a portion of an example implementation of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

As introduced herein, a communication system provides visual information bi-directionally between communication devices (e.g., smart glasses and tablet computers (referred to as “tablets”)) associated with field equipment operated by field personnel (or workers) and a supervisor at a control center of an oilfield wellsite. An area around the field equipment (e.g., wellsite equipment) can be managed remotely from the control center. In this manner, context-aware information for operation of the wellsite is provided to and from the control center. In addition, the supervisor at the control center can assign tasks and provide supporting information to the communication devices over a bidirectional wireless communication path to facilitate real-time status updates and remedial action.

The communication system may be utilized with various types of physical equipment such as equipment at an oilfield wellsite or other job sites such as, without limitation, a manufacturing facility and a construction site. In an oilfield environment, the physical equipment can be located at the wellsite, stationed at an oilfield base facility, repaired at a maintenance shop, and/or transported between the wellsite and the base facility.

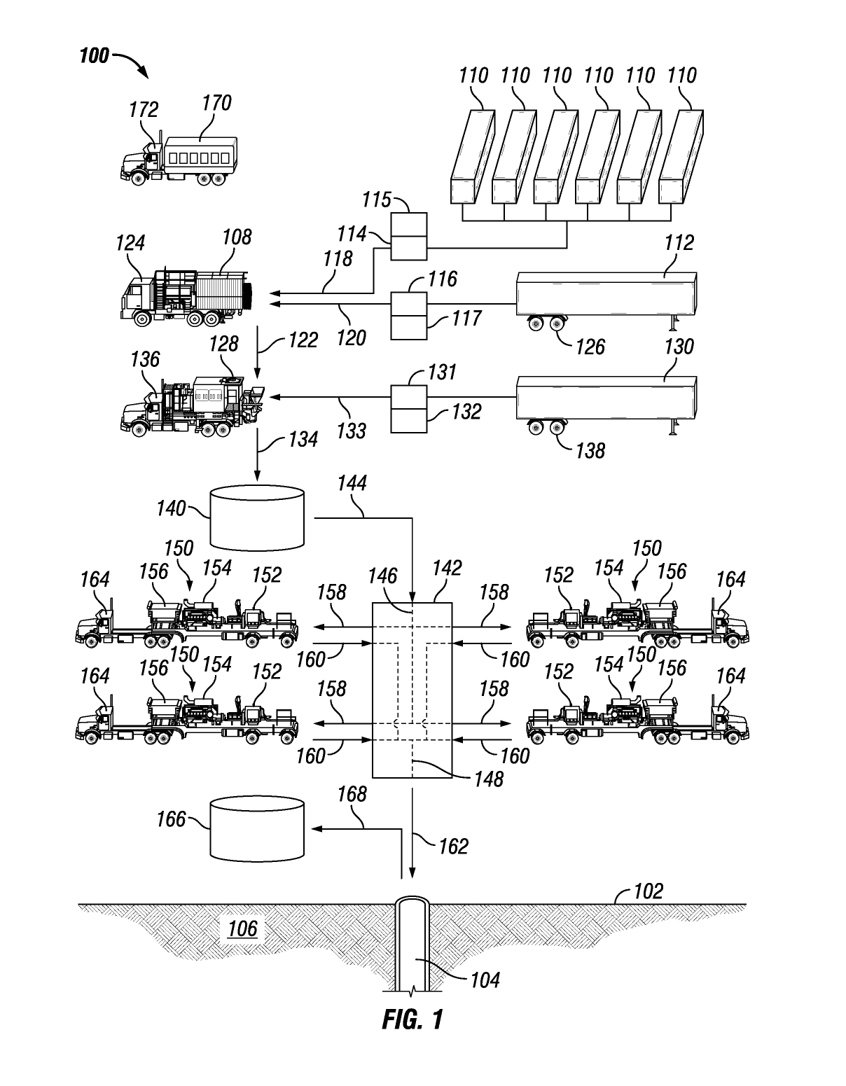

FIG. 1 is a schematic view of at least a portion of an additive system 100 at an oilfield wellsite that provides an environment for a communication system according to one or more aspects of the present disclosure. The figure depicts a wellsite surface 102 adjacent to a wellbore 104 and a partial sectional view of the subterranean formation 106 penetrated by the wellbore 104 below the wellsite surface 102. The additive system 100 may be operable to transfer an additive or other material from a source location to a destination location for blending or mixing with another additive or material and eventual injection into the wellbore 104. The additive system 100 may comprise a first mixer 108 connected with one or more first containers 110 and a second container 112. The second container 112 may contain a first additive and the first containers 110 may contain water or another liquid comprising water. When the additive system 100 is operable as a fracturing system, the first additive may be or comprise a hydratable material or gelling agent, such as guar, a polymer, a synthetic polymer, a galactomannan, a polysaccharide, a cellulose, and/or a clay, among other examples, and the liquid may be or comprise an aqueous fluid, which may comprise water or an aqueous solution comprising water, among other examples. When the additive system 100 is operable as a cementing system, the first additive may be or comprise cement powder.

The liquid may be transferred from the first containers 110 to the first mixer 108 by a first material transfer device 114, such as may be driven by a first prime mover 115. The first material transfer device 114 may be or comprise a pump, while the prime mover 115 may be or comprise an electric motor, an engine, or another rotary actuator. The first additive may be transferred from the second container 112 to the first mixer 108 by a second material transfer device 116, such as may be driven by a second prime mover 117. The second material transfer device 116 may be or comprise a conveyer, a bucket elevator, or a feeding screw, while the second prime mover 117 may be or comprise an electric motor, an engine, or another rotary actuator. The first mixer 108 may be operable to receive the first additive and the liquid via two or more conduits 118, 120, and mix or otherwise combine the first additive and the liquid to form a base fluid. The first mixer 108 may then discharge the base fluid via one or more conduits 122.

The first mixer 108 and the second container 112 may each be disposed on corresponding trucks, trailers, and/or other mobile carriers 124, 126, respectively, to permit their transportation to the wellsite surface 102. However, the first mixer 108 and/or second container 112 may be skidded or otherwise stationary, and/or may be temporarily or permanently installed at the wellsite surface 102.

The additive system 100 may further comprise a second mixer 128 fluidly connected with the first mixer 108 and a third container 130. The third container 130 may contain a second additive that may be substantially different than the first additive. When the additive system 100 is operable as the fracturing system, the second additive may be or comprise a proppant material, such as sand, sand-like particles, silica, quartz, and/or propping agents, among other examples. When the additive system 100 is operable as the cementing system, the second additive may be or comprise accelerators, retarders, fluid-loss additives, dispersants, extenders, weighting agents, lost circulation additives and/or other chemicals or materials operable to modify the characteristics of the base fluid. The second additive may be a solid material (e.g., particulate material, powder) or a liquid.

The second additive may be transferred from the third container 130 to the second mixer 128 by a third material transfer device 131 driven by a third prime mover 132. The third material transfer device 131 may be or comprise a pump when the second additive is a liquid, or the third material transfer device 131 may be or comprise a conveyer, a bucket elevator, or a feeding screw when the second additive is a solid material. The third prime mover 132 may be or comprise an electric motor, an engine, or another rotary actuator. The second mixer 128 may be operable to receive the base fluid from the first mixer 108 via one or more conduits 122, and a second additive from the third container 130 via one or more conduits 133, and mix or otherwise combine the base fluid and the second additive to form a mixture. The mixture may comprise a fracturing fluid when the additive system 100 is operable as the fracturing system, or the mixture may comprise a cement slurry when the additive system 100 is operable as the cementing system. The second mixer 128 may then discharge the mixture via one or more conduits 134.

The second mixer 128 and the third container 130 may each be disposed on corresponding trucks, trailers, and/or other mobile carriers 136, 138, respectively, to permit their transportation to the wellsite surface 102. However, the second mixer 128 and/or third container 130 may be skidded or otherwise stationary, and/or may be temporarily or permanently installed at the wellsite surface 102.

The mixture may be communicated from the second mixer 128 to a fourth container 140, which may be or comprise a mixing, displacement, or storage tank for the mixture prior to being injected into the wellbore 104. The mixture may be communicated from the fourth container 140 to a common manifold 142 via the one or more conduits 144. The common manifold 142 may comprise a combination of valves and/or diverters, as well as a suction line 146 and a discharge line 148, such as may be collectively operable to direct flow of the mixture in a selected or predetermined manner. The common manifold 142, which may be known in the art as a missile or a missile trailer, may distribute the mixture to a pump fleet. The pump fleet may comprise multiple pump assemblies 150 each comprising a pump 152, a prime mover 154, and a heat exchanger 156. Each pump assembly 150 may receive the mixture from the suction line 146 of the common manifold 142, via one or more conduits 158, and discharge the mixture under pressure to the discharge line 148 of the common manifold 142, via one or more conduits 160.

The pump assemblies 150 may each be mounted on corresponding trucks, trailers, and/or other mobile carriers 164, such as may permit their transportation to the wellsite surface 102. However, the pump assemblies 150 may be skidded or otherwise stationary, and/or may be temporarily or permanently installed at the wellsite surface 102.

The mixture may then be discharged from the common manifold 142 into the wellbore 104 via one or more conduits 162, such as may include various valves, conduits, and/or other hydraulic circuitry fluidly connected between the common manifold 142 and the wellbore 104. During operations, the mixture and/or wellbore fluid may be ejected from the wellbore 104 and communicated to a fifth container 166 via one or more conduits 168. Although the additive system 100 is shown comprising a fourth container 140, it is to be understood that the fourth container 140 may not be included as part of the additive system 100, such that the mixture may be communicated from the second mixer 128 directly to the common manifold 142. The additive system 100 may also omit the common manifold 142, and the conduits 160 may be fluidly connected to the wellbore 104 via a wellhead (not shown) and/or other means.

The additive system 100 may also comprise a control center 170, which may be operable to monitor and control at least a portion of the additive system 100 during operations. Signals may be communicated between the control center 170 and other components of the additive system 100 via a local network. For example, the control center 170 may be operable to monitor and/or control the production rate of the mixture, such as by increasing or decreasing the flow of the liquid from the first containers 110, the first additive from the second container 112, the base fluid from the first mixer 108, the second additive from the third container 130, and/or the mixture from the second mixer 128. The control center 170 may also be operable to monitor health and/or functionality of the additive system 100. For example, the control center 170 may be operable to monitor and/or control operational parameters associated with the containers 110, 112, 130, 140, 166, the first and second mixers 108, 128, the material transfer assemblies 114, 116, 131, and/or the pump assemblies 150. The control center 170 may also be operable to monitor temperature, viscosity, density, and composition of the liquid contained in the first containers 110, the first additive, the second additive, and/or the mixture. The control center 170 may also communicate with communication devices to permit a supervisor to assign tasks to field personal to operate the additive system 100, or portions thereof, based on information (e.g., visual information) shared therebetween. Control signals may be communicated between the control center 170 and other wellsite equipment via electric conductors (not shown). Control signals may also be communicated between the control center 170 and the communication devices associated with the field personnel operating the wellsite equipment via a communication path (e.g., a wireless communication path). Any type of signal communication is within the scope of the present disclosure.

The control center 170 may be disposed on a corresponding truck, trailer, cabin, and/or other mobile carrier 172, such as may permit its transportation to the wellsite surface 102. However, the control center 170 may be skidded or otherwise stationary, and/or may be temporarily or permanently installed at the wellsite surface 102.

FIG. 1 depicts the additive system 100 as being operable to transfer additives and produce mixtures that may be pressurized and injected into the wellbore 104 during hydraulic fracturing or cementing operations. However, it is to be understood that the additive system 100 may be operable to transfer other additives and produce other mixtures that may be pressurized and injected into the wellbore 104 during other oilfield operations, such as drilling, acidizing, chemical injecting, and/or water jet cutting operations, among other examples. While the communication system as described herein will be described in the environment of an additive system 100, it is to be understood that the communication system for assigning tasks between the control center 170 and communication devices associated with the field personnel may be implemented during other oilfield operations, such as drilling, cementing, acidizing, chemical injecting, and/or water jet cutting operations, among other examples, and other job site operations.

The communication system employs communication devices such as smart glasses or other portable or wearable equipment to permit a wellsite supervisor at a control center furnished with a central repository of information on a human-machine interface (HMI) to push information about a job via communication paths to display on the communication devices accessible by field workers. The displayed information can be selected by the wellsite supervisor and formatted to better fit the size of the display of the communication devices. Further, the displayed information can change in real-time in accordance with the originating human-machine interface and facilitate performing certain tasks by the field workers. At the remote communication device, with processing power implemented right in front of a worker's line of sight, the field workers (such as equipment operators) can serve as mobile sensors to detect issues, provide context-aware equipment health, and deliver real-time information about operating parameters of the field equipment to the control center.

Additional enhancements include providing a connection to offsite personnel that can assess an operation of a wellsite via visual content and provide real-time recommendations to the control center and communication devices at the wellsite. The wellsite supervisor and field personnel can, therefore, take advantage of a form of augmented reality with visual information to provide recommendations to increase efficiency and visibility with which equipment is operated.

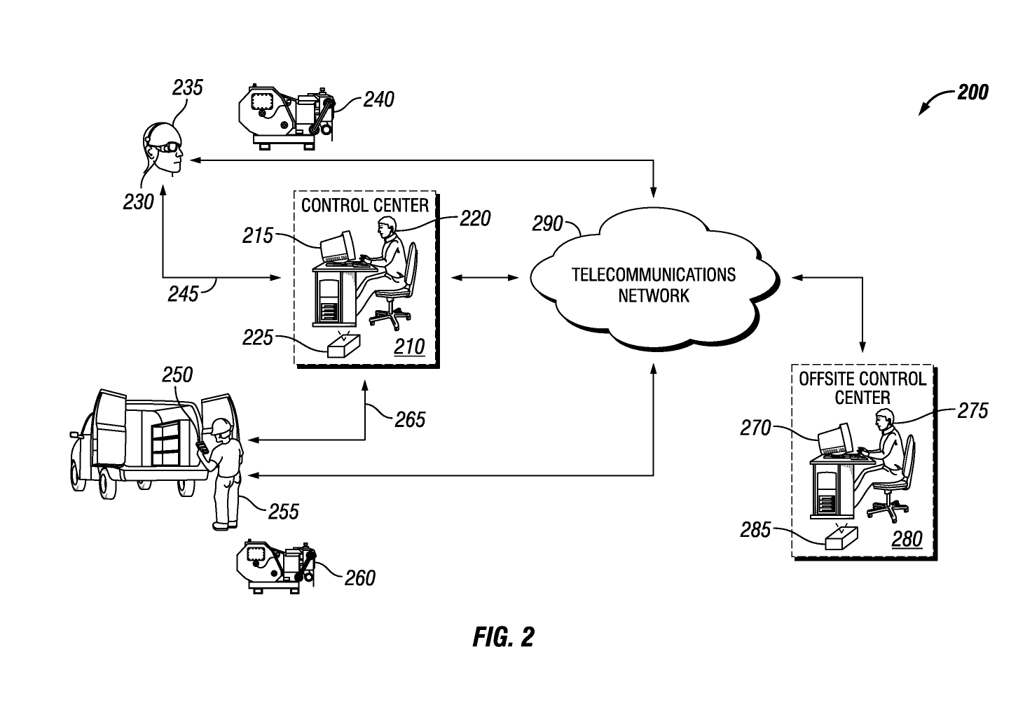

FIG. 2 is a system level view of a communication system 200 according to one or more aspects of the present disclosure. The communication system 200 includes a control center 210 including a computer 215 operated by a supervisor 220 at an oilfield wellsite. The computer 215 can send information to and receive information from a remote location via a communications router 225 (e.g., a wireless communications router) of the control center 210. The communications router 225 serves as an access point for communication device(s) at the oilfield wellsite as well as a gateway to permit the control center 210 to communicate with remote communication device(s) and/or offsite control center(s). The control center 210 communicates with a first communication device 230 (e.g., smart glasses) associated with a first field worker 235 operating a first wellsite equipment 240 over a first communication path 245 (e.g., a wireless communication path). The control center 210 communicates with a second communication device 250 (e.g., a tablet) associated with a second field worker 255 operating a second wellsite equipment 260 over a second communication path 265 (e.g., a wireless communication path). For example, the first wellsite equipment 240 and/or the second wellsite equipment 260 may form a portion of one of the pump assemblies 150 introduced above with respect to FIG. 1. The control center 210 communicates with an offsite computer 270 operated by an offsite supervisor 275 at an offsite control center 280 via a communications router 285 coupled to a telecommunications network 290. The offsite control center 280 may be associated with another wellsite. The first and second communication devices 230, 250 can communicate with the offsite control center 280 either indirectly via the control center 210 or more directly via connection to the telecommunications network 290.

Thus, real-time information is communicated to the first and second field workers 235, 255 via the first and second communication devices 230, 250 to perform tasks on the first and second wellsite equipment 240, 260, respectively. The real-time information traverses the first and second wireless communication paths 245, 265, which may be embodied in a wireless fidelity (Wi-Fi) communications path. The information shared between the supervisor 220 and the first and second field workers 235, 255 is presented on displays of the respective computer 215, and the first and second communication devices 230, 250. Thus, the supervisor 220 shares real-time visual information for the operation of the first and second wellsite equipment 240, 260 for execution by the first and second field workers 235, 255, respectively.

In addition, the first and second communication devices 230, 250 can provide real-time visual information about operational parameters about the first and second wellsite equipment 240, 260, respectively, to the computer 215 at the control center 210 to permit the supervisor 220 to assign remedial tasks and/or make recommendations to operate the same. The visual information may be in the form of an image or video of the first and second wellsite equipment 240, 260 taken by the first and second communication devices 230, 250, respectively. The supervisor 220 can also provide the visual information about the first and second wellsite equipment 240, 260 from the computer 215 to the offsite computer 270 to permit the offsite supervisor 275 at the offsite control center 280 to make recommendations as well. Additionally, the first and second communication devices 230, 250 can provide the visual information about the first and second wellsite equipment 240, 260 to the offsite supervisor 275 at the offsite control center 280 to make recommendations.

In making the recommendations, for example, to the first field worker 235, the supervisor 220 can assign a task and share part of the display of the computer 215 with the display of the first communication device 230. The first field worker 235 can now see images visible or otherwise accessible to the supervisor 220 on the display of the first communication device 230 to facilitate an efficient completion of the assigned task. Thus, the first field worker 235 can perform the task with a higher level of independence with remote assistance by the supervisor 220.

The first field worker 235 can also send visual content of operating parameters of the first wellsite equipment 240 via the first communication device 230 to the computer 215 of the supervisor 220 in real-time so that the supervisor 220 has more comprehensive and relevant up-to-date information about the conditions of the first wellsite equipment 240. Based thereon, the supervisor 220 can collaborate with the first field worker 235 to ascertain a viable solution (e.g., an updated task) to operate the first wellsite equipment 240.

By providing access to the repository of information available at the computer 215 of the control center 210, the first field worker 235 may also access the information via the first communication device 230 and, with a higher level of reliability, independently set a course of action to operate the first wellsite equipment 240. The control center 210 becomes an information conduit, and the first field worker 235 may not need continuous, direct personal input from the supervisor 220. The result is the supervisor 220 shares the computer 215 with the first communication device 230 and may thus avoid giving continuous instructions to the first field worker 235. Additionally, the first field worker 235 can obtain access to the offsite computer 270 to permit the offsite supervisor 275 to provide recommendations in addition to or in lieu of the supervisor 220. If the offsite control center 280 is associated with another wellsite, the first field worker 235 can obtain access to the offsite supervisor 275 via a mesh communication system including the computer 215 at the control center 210 serving the supervisor 220 and the offsite computer 270 at the offsite control center 280 serving the offsite supervisor 275. While the aforementioned implementations have been described with respect to the first wellsite equipment 240, the principles are equally applicable to other wellsite equipment such as the second wellsite equipment 260.

In general, control of a wellsite is performed by an onsite supervisor. With the communication system as set forth herein, information such as visual images and other wellsite data such as pressures, material remaining in a container and the particular equipment at the wellsite can be communicated from the field workers at the wellsite to an offsite control center at another wellsite. This permits equipment at a particular wellsite to be operated based on what is happening at or recommendations from different, remote wellsites. A field worker at the wellsite can review visual information from another field worker at another wellsite, which permits a higher level of coordination therebetween. A communication path to an offsite supervisor via the control center at the wellsite (or otherwise) permits the offsite supervisor to provide coordinating information back to the local supervisor.

Equipment at a wellsite may include a human-machine interface (HMI) and is controlled by the communication system at the control center. Operational data from various pieces of equipment are transmitted to the control center. At a conventional wellsite facility, field workers generally don't have access to data that is visible or otherwise available to a supervisor at the control center. As introduced herein, when a field worker needs to increase, decrease, or at least be aware of a pressure in a pipe, for example, that information can be provided over a bidirectional communication path from the control center to the field worker via a human-machine interface such as available with smart glasses. The result is that a field worker can complete a task with a greater level of independence and efficiency.

The process is scalable as the number of supervisors and field workers increases at a wellsite. This permits one field worker continually to see what another field worker sees, as well as what is on a display or screen of a computer of the supervisor. The information that a field worker can see can be restricted to be pertinent to a particular job. Collaboration among a plurality of field workers can occur. A wireless communication path from one supervisor to another supervisor can be provided, whether at the same or different wellsites.

The communication system permits a supervisor to monitor several wellsites. For example, a supervisor may be monitoring a high-pressure area at a local wellsite, which may be a high priority. At the same time, the supervisor may be asked to assess a problem a field engineer or worker is experiencing with a sand blender at another wellsite. The field engineer notices that sand is not falling into the sand blender even though the sand silo feeding the sand blender is full. The supervisor can now use a communication device of the field engineer to continue working therewith on the sand blender issue, while polling the high-pressure area's pressure reading using the control center at the local wellsite.

The communication system permits a field worker to operate with some level of independence. For example, a field worker may be tasked to prime up pipes. Employing the communication device attached to the field worker, the field worker can access the computer at the control center via the communication device to observe the target pipe pressure readings and adjust the valves to meet the target readings. Thus, the field worker can independently operate the pipe system, thereby permitting the supervisor at the control center to actively monitor other operations at the wellsite or elsewhere. The supervisor can, therefore, multi-task using the communication system as set forth herein.

The communication system supports real-time video to supervise a task. For example, a field worker may be tasked to fix a problem with a distributed control unit (DCU) on a coiled tubing unit. The field worker may observe that light-emitting diodes (LEDs) associated with the distributed control unit exhibit a particular blinking pattern. The field worker may not be sufficiently experienced to ascertain what has gone wrong based on the observed LEDs debugging pattern. To obtain further assistance, the field worker streams a video of the operation of the LEDs via a communication device to the control center for a recommendation from the supervisor.

As an example of broadcasting a self-help information scenario, a supervisor receives a request from a field worker to review an LED pattern to assist debugging a control board. The supervisor currently has another request to be fulfilled from another field worker. The supervisor, however, sends a guide from a computer at the control center to the communication device of the field worker, which details the LED patterns and corresponding control board issues. The field worker can then read the information in real-time to assess the LED pattern.

The communication system supports the use of information for training materials to assist field workers. For example, a field worker may inspect wellsite equipment to fix a DCU issue. Employing a communication device, the field worker can record the repair to archive at the control center. If the communication device is smart glasses, the field worker can record the video hands-free. As a result, the control center can create a video library of pertinent repairs for a wellsite taken from the perspective of the field worker.

As an example of a collaboration to perform a pumping test, a field worker on a gel linker mixer may be better served by collaborating with another field worker located at a blender. The corresponding communication devices of the field workers can communicate to permit each field worker to observe the operational parameters or states associated with each other's wellsite equipment in real-time. While a supervisor at the control center may monitor the interaction and tasks, the field workers have pertinent system-level information to more accurately operate their respective wellsite equipment.

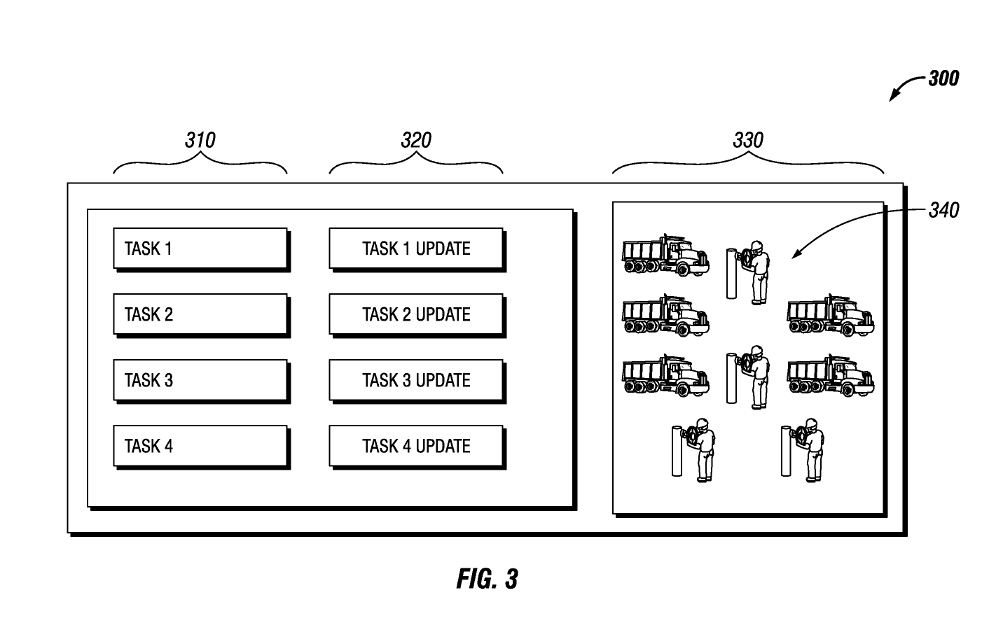

FIG. 3 is a screen shot of a display 300 of a computer of control center of a communication system according to one or more aspects of the present disclosure. The display 300 comprises a task window 310 including a plurality of tasks designated Task 1 to Task 4. The display 300 also comprises a task update window 320 including a plurality of updated tasks designated Task 1 Update to Task 4 Update. The display 300 still further comprises a symbolic device window 330 including a plurality of avatars (one of which is designated 340).

A field worker can be assigned a task such as Task 1 for field equipment by dragging and dropping (via, for example, an input device like a mouse) an icon for the Task 1 onto an avatar 340 (representing the field worker) within the symbolic device window 330. The computer of the control center then communicates with a communication device associated with the field worker to perform the assigned Task 1. The Task 1 can be provided with visual information from the computer at the control center to the communication device. The communication device can then create visual content (or representation) of operating parameters of the field equipment in response to the assigned Task 1 and provide the visual content to the computer at the control center. Based thereon, the computer can assign an updated task such as Task 1 Update for the field equipment by dragging and dropping an icon for Task 1 Update onto the avatar 340 (representing the field worker) within the symbolic device window 330. The Task 1 Update can be provided with updated visual information to the communication device. Thus, dragging and dropping icons representing tasks, updated tasks, and field workers, among other things, is an efficient manner to communicate job site tasks between the computer at the control center and communication devices associated with field equipment and/or field workers.

In an environment of an oilfield wellsite, many different kinds of field equipment generally run at the same time. For example, a blender that pumps a gel down a wellbore may be operated. At the same time, in a mixer or blender operation, a bulk container might be plugged up or be empty. A field worker may walk over to the blender or other wellsite equipment and use a communication device such as smart glasses, a smartphones, or a tablet, to produce visual content (e.g., a picture and/or video) to show that sand is not discharging correctly from the enclosure. If something is not working properly, the visual content may be immediately sent to the control center. The supervisor can observe the field equipment via a computer and assign a task in real-time to address the situation. The supervisor thereby can obtain a richer set of information that shows what is happening, and provide a quick remedial response to the communication device of the field worker.

The communication system can address many job site tasks as set forth in the examples that follow. In managing on-site personnel competency, a supervisor observes that a sophisticated piece of field equipment, such as a blender, is not operating correctly. For example, a proppant concentration may be oscillating around a design target and is not settling. Based on a personal competency record shown next to each field worker's avatar, the supervisor observes that a particular field worker has four stars out of five for fixing blender issues. The supervisor then assigns the aforementioned task to the competent field worker. The supervisor observes that a piece of field equipment, such as a high-pressure stimulation pump, is not operating correctly by observing that a hose connection has started to vibrate. Since this is a common but time-sensitive issue, the supervisor assigns the closest field worker to the equipment to attend to this issue in an expeditious manner.

A supervisor may assign a first field worker to lay out high-pressure pumps for a stimulation job configuration, a second field worker to prepare to prime up the pumps for the job, and a third field worker to place sand into a sand chief, etc. In the meantime, each field worker can send back updated job status (e.g., job twenty percent completed) with visual content and, accordingly, the supervisor is apprised about the readiness of the entire stimulation job, which aids the supervisor in advising the client of accurate job status information on site.

As an example of employing a drag-and-drop interface to assign a task to a field worker, when a supervisor notices field equipment experiencing trouble via a communication device of a field worker, the supervisor can then view the competencies and positions of each crew member, and drag and drop their corresponding avatars to the field equipment to expedite the job assignments. The communication system can also accumulate statistics over time. A supervisor can use the communication system during the execution of a job to keep track of what equipment became faulty, how long it took to fix the fault, who fixed the fault, etc. In turn, the compiled information is accessible at the control center, including each field personnel's competency ratings for future use.

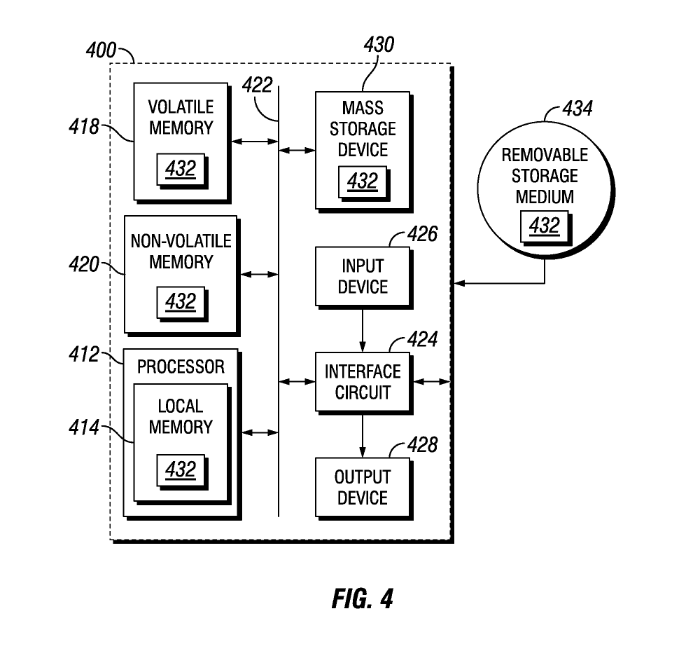

FIG. 4 is a schematic view of at least a portion of an example implementation of an apparatus of a communication system according to one or more aspects of the present disclosure. The apparatus may form a communication device and computer, among other things, of the communication system. The apparatus is or comprises a processing system 400 that may execute example machine-readable instructions to implement at least a portion of one or more of the methods and/or processes described herein, and/or to implement an assignment and management of tasks to perform operations at a job site. The processing system 400 may be or comprise, for example, one or more processors, controllers, special-purpose computing devices, servers, personal computers, personal digital assistant (PDA) devices, smartphones, smart glasses, tablets, internet appliances, and/or other types of computing devices. Moreover, while it is possible that the entirety of the processing system 400 shown in FIG. 4 is implemented within the apparatus, it is also contemplated that one or more components or functions of the processing system 400 may be external to the processing system 400.

The processing system 400 may comprise a processor 412 such as, for example, a general-purpose programmable processor. The processor 412 may comprise a local memory 414, and may execute coded instructions 432 present in the local memory 414 and/or another memory device. The processor 412 may execute, among other things, machine-readable instructions or programs to implement the methods and/or processes described herein. The programs stored in the local memory 414 may include program instructions or computer program code that, when executed by an associated processor, permit surface equipment at a wellsite or offsite to perform tasks as described herein. The processor 412 may be, comprise, or be implemented by one or a plurality of processors of various types suitable to the local application environment, and may include one or more of general- or special-purpose computers, microprocessors, digital signal processors (DSPs), field-programmable gate arrays (FPGAs), application-specific integrated circuits (ASICs), and processors based on a multi-core processor architecture, as non-limiting examples. Other processors from other families are also appropriate.

The processor 412 may be in communication with a main memory, such as may include a volatile memory 418 and a non-volatile memory 420, perhaps via a bus 422 and/or other communication means. The volatile memory 418 may be, comprise, or be implemented by random access memory (RAM), static random access memory (SRAM), synchronous dynamic random access memory (SDRAM), dynamic random access memory (DRAM), RAMBUS dynamic random access memory (RDRAM) and/or other types of random access memory devices. The non-volatile memory 420 may be, comprise, or be implemented by read-only memory, flash memory and/or other types of memory devices. One or more memory controllers (not shown) may control access to the volatile memory 418 and/or the non-volatile memory 420.

The processing system 400 may also comprise an interface circuit 424. The interface circuit 424 may be, comprise, or be implemented by various types of standard interfaces, such as an Ethernet interface, a universal serial bus (USB), a third generation input/output (3GIO) interface, a wireless interface, and/or a cellular interface, among others. The interface circuit 424 may also comprise a graphics driver card. The interface circuit 424 may also comprise a device such as a modem or network interface card to facilitate exchange of data with external computing devices via a network (e.g., Ethernet connection, digital subscriber line (DSL), telephone line, coaxial cable, cellular telephone system, satellite, etc.).

One or more input devices 426 may be connected to the interface circuit 424. The input device(s) 426 may permit a user to enter data and commands into the processor 412. The input device(s) 426 may be, comprise, or be implemented by, for example, a keyboard, a mouse, a touchscreen, a track-pad, a trackball, an isopoint, and/or a voice recognition system, among others. The input device(s) 426 may comprise an image-capturing device configured to capture an image or video and provide visual content of field equipment at a job site.

One or more output devices 428 may also be connected to the interface circuit 424. The output devices 428 may be, comprise, or be implemented by, for example, display devices (e.g., a liquid crystal display or cathode ray tube display (CRT), among others), printers, and/or speakers, among others.

The processing system 400 may also comprise one or more mass storage devices 430 for storing machine-readable instructions and data. Examples of such mass storage devices 430 include floppy disk drives, hard drive disks, compact disk (CD) drives, and digital versatile disk (DVD) drives, among others. The coded instructions 432 may be stored in the mass storage device 430, the volatile memory 418, the non-volatile memory 420, the local memory 414, and/or on a removable storage medium 434, such as a CD or DVD. Thus, the modules and/or other components of the processing system 400 may be implemented in accordance with hardware (embodied in one or more chips including an integrated circuit such as an ASIC), or may be implemented as software or firmware for execution by a processor. In particular, in the case of firmware or software, the embodiment can be provided as a computer program product including a computer readable medium or storage structure embodying computer program code (i.e., software or firmware) thereon for execution by the processor.

The present disclosure introduces a communication device (e.g., smart glasses, a smartphone, or a tablet computer) proximate field equipment on a job site and operable to communicate (via, for example, a wireless communication path) with a control center. The communication device includes a processor 412 and memory (e.g., the memory 414) including computer program code (e.g., coded instructions 432) that cause the communication device to receive visual information for a task for operating the field equipment from the control center, format and display the visual information, create visual content of operating parameters of the field equipment in response to the task, provide the visual content to the control center, receive updated visual information for an updated task in response to the visual content for operating the field equipment from the control center, and format and display the updated visual information. The control center may be remote from the job site. The communication device may perform each, or ones of, the aforementioned operations in real-time. If the job site is an oilfield wellsite and the field equipment is wellsite equipment, then the visual information and updated visual information represents oilfield tasks for operating the wellsite equipment.

The present disclosure also introduces an apparatus (e.g., a personal computer) operable to communicate (via, for example, a wireless communication path) with a communication device proximate field equipment on a job site. The apparatus includes a processor 412 and memory (e.g., the memory 414) including computer program code (e.g., coded instructions 432) that cause the apparatus to assign a task for operating the field equipment, create visual information demonstrating the task, format and provide the visual information to the communication device, receive visual content of operating parameters of the field equipment in response to the task, assign an updated task for operating the field equipment in response to the visual content, create updated visual information demonstrating the updated task, and format and provide the updated visual information to the communication device. The apparatus may be remote from the job site.

The processor 412 and memory 414 including computer program code 432 may cause the apparatus to monitor the operating parameters via the visual content. The processor 412 and memory 414 including computer program code 432 may also cause the apparatus to provide the visual information and/or the updated visual information to another communication device. The processor 412 and memory 414 including computer program code 432 may also cause the apparatus to perform each, or ones of, the aforementioned operations to the another communication device and, at the same time and in real-time, with the operations associated with the communication device. The apparatus can assign the task and the updated task through a drag and drop operation on a display of the apparatus.

In at least one implementation within the scope of the present disclosure, the apparatus is located at the job site and is operable to communicate with an offsite control center. The processor 412 and memory 414 including computer program code 432 may cause the apparatus to provide the visual content to the offsite control center, and assign the updated task for operating the field equipment in response to the visual content in collaboration with the offsite control center. If the job site is an oilfield wellsite and the field equipment is wellsite equipment, then the visual information and updated visual information represents oilfield tasks for operating the wellsite equipment.

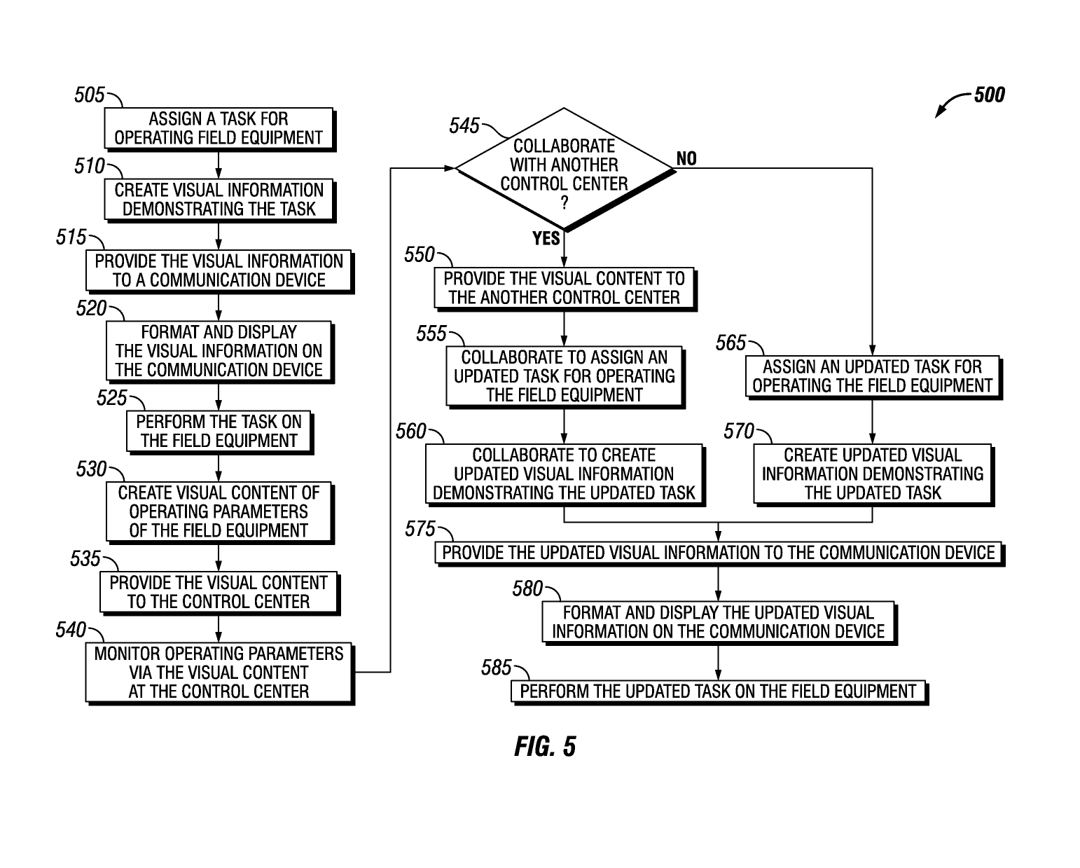

FIG. 5 is a flow-chart diagram of at least a portion of an example implementation of a method (500) according to one or more aspects of the present disclosure. The method (500) may be performed utilizing at least a portion of one or more implementations of the apparatus shown in FIG. 4 and/or otherwise within the scope of the present disclosure, including assigning and managing tasks for field equipment at a job site shown in one or more of FIGS. 1-3 and/or otherwise within the scope of the present disclosure.

The method (500) is operable to control (e.g., in real-time) a communication system comprising a control center communicating over a communication path (e.g., a wireless communication path) with a communication device (e.g., smart glasses, a smartphone, or a tablet computer) proximate field equipment on a job site. The control center may be located at the job site or be an offsite control center located remote from the job site including another job site. The method (500) includes assigning (505) a task for operating the field equipment at the control center. The control center can assign (505) the task by a drag and drop operation on a display of a computer at the control center, including employing an icon and an avatar on the display of the computer.

The control center then creates (510) visual information demonstrating the task and provides (515) the visual information to the communication device. The control center can also provide the visual information to another communication device. The method (500) also includes formatting and displaying (520) the visual information on the communication device and performing (525) the task on the field equipment in accordance with the visual information demonstrating the task. The communication device then creates (530) visual content of operating parameters of the field equipment in response to the task and provides (535) the visual content to the control center. The control center monitors (540) the operating parameters via the visual content provided thereto.

The method (500) then determines if the control center will collaborate (545) with another control center (e.g., an offsite control center). If the control center will collaborate (545) with another control center, the control center provides (550) the visual content to the other control center. The control centers then collaborate to assign (555) an updated task for operating the field equipment in response to the visual content and create (560) updated visual information demonstrating the updated task. If the control center does not collaborate (540) with another control center, the control center assigns (565) an updated task for operating the field equipment in response to the visual content and creates (570) updated visual information demonstrating the updated task. The control center(s) can assign the updated task by a drag and drop operation on a display of a computer at the control center(s) including employing an icon and an avatar on the display of the computer.

The method (500) then includes providing (575) the updated visual information to the communication device. The method (500) can also provide the updated visual information to another communication device. The communication device then formats and displays (580) the updated visual information thereon and performs (585) the updated task on the field equipment in accordance with the updated visual information demonstrating the updated task. The visual information, the visual content, and the updated visual information may comprise an image and/or a video.

While the method (500) has principally been described with respect to a single communication device proximate field equipment on a job site, it should be understood that the communication system is scalable to a plurality of communication devices proximate corresponding field equipment on a plurality of job sites. Also, the job site may be an oilfield wellsite, the field equipment may be wellsite equipment, and the visual information and the updated visual information may represent an oilfield task for operating the wellsite equipment.

In view of the entirety of the present application, including the figures and the claims, a person having ordinary skill in the art should readily recognize that the present disclosure introduces a method of operating a communication system between a control center and a communication device proximate field equipment on a job site, comprising: assigning a task for operating the field equipment at the control center; creating visual information demonstrating the task; providing the visual information to the communication device; displaying the visual information on the communication device; creating visual content of operating parameters of the field equipment in response to the task; providing the visual content to the control center; assigning an updated task for operating the field equipment in response to the visual content at the control center; creating updated visual information demonstrating the updated task; providing the updated visual information to the communication device; and displaying the updated visual information on the communication device.

The control center may be remote from the job site.

The control center may be located at the job site, and the method may further comprise: providing the visual content to another, offsite control center; and assigning the updated task for operating the field equipment in response to the visual content at the control center in collaboration with the offsite control center.

The method may further comprise formatting the visual information for display on the communication device.

The method may further comprise monitoring the operating parameters via the visual content at the control center.

The method may further comprise providing the visual information and/or the updated visual information to another communication device.

Another communication device may be proximate another field equipment on the job site, and the method may further comprise: assigning another task for operating the another field equipment at the control center; creating another visual information demonstrating the another task; providing the another visual information to the another communication device; displaying the another visual information on the another communication device; creating another visual content of another operating parameters of the another field equipment in response to the another task; providing the another visual content to the control center; assigning another updated task for operating the another field equipment in response to the another visual content at the control center; creating another updated visual information demonstrating the another updated task; providing the another updated visual information to the another communication device; and displaying the another updated visual information on the another communication device.

Assigning the task and the updated task may comprise a drag and drop operation on a display of a computer of the control center.

Assigning the task and the updated task may comprise employing an icon and an avatar on a display of a computer of the control center.

The visual information, the visual content, and the updated visual information may comprise an image and/or a video.

The communication device may be selected from the group consisting of: smart glasses; a smartphone; and a tablet computer.

The control center and the communication device may communicate over a wireless communication path.

The method may be performed in real-time.

The job site may be an oilfield wellsite, the field equipment may be wellsite equipment, and the visual information may represent an oilfield task for operating the wellsite equipment.

The present disclosure also introduces an apparatus operable to communicate with a communication device proximate field equipment on a job site, comprising: a processor; and a memory including computer program code, wherein the processor, the memory, and the computer program code are collectively operable to cause the apparatus to: assign a task for operating the field equipment; create visual information demonstrating the task; provide the visual information to the communication device; receive visual content of operating parameters of the field equipment in response to the task; assign an updated task for operating the field equipment in response to the visual content; create updated visual information demonstrating the updated task; and provide the updated visual information to the communication device.

The apparatus may be remote from the job site.

The apparatus may be located at the job site, and the processor, the memory, and the computer program code may be further collectively operable to cause the apparatus to: provide the visual content to an offsite control center; and assign the updated task for operating the field equipment in response to the visual content in collaboration with the offsite control center.

The processor, the memory, and the computer program code may be further collectively operable to cause the apparatus to format the visual information for display on the communication device.

The processor, the memory, and the computer program code may be further collectively operable to cause the apparatus to monitor the operating parameters via the visual content.

The processor, the memory, and the computer program code may be further collectively operable to cause the apparatus to provide the visual information and/or the updated visual information to another communication device.

The apparatus may further comprise another communication device proximate another field equipment on the job site, and the processor, the memory, and the computer program code may be further collectively operable to cause the apparatus to: assign another task for operating the another field equipment; create another visual information demonstrating the another task; provide the another visual information to the another communication device; receive another visual content of another operating parameters of the another field equipment in response to the another task; assign an updated another task for operating the another field equipment in response to the another visual content; create another updated visual information demonstrating the another updated task; and provide the another updated visual information to the another communication device.

The processor, the memory, and the computer program code may be further collectively operable to cause the apparatus to assign the task and the updated task through a drag and drop operation on a display of the apparatus.

The communication device may be selected from the group consisting of: smart glasses; a smartphone; and a tablet computer.

The apparatus may be operable to communicate with the communication device over a wireless communication path.

The processor, the memory, and the computer program code may be further collectively operable to cause the apparatus to assign the updated task in response to the visual content, create the updated visual information, and provide the updated visual information to the communication device in real-time.

The job site may be an oilfield wellsite, the field equipment may be wellsite equipment, and the visual information may represent an oilfield task for operating the wellsite equipment.

The present disclosure also introduces an apparatus proximate field equipment on a job site operable to communicate with a control center, comprising: a processor; and a memory including computer program code, wherein the processor, the memory, and the computer program code are collectively operable to cause the apparatus to: receive visual information for a task for operating the field equipment from the control center; display the visual information; create visual content of operating parameters of the field equipment in response to the task; provide the visual content to the control center; receive updated visual information for an updated task in response to the visual content for operating the field equipment from the control center; and display the updated visual information.

The control center may be remote from the job site.

The processor, the memory, and the computer program code may be further collectively operable to cause the apparatus to format the visual information for display on the apparatus.

The apparatus may be selected from the group consisting of: smart glasses; a smartphone; and a tablet computer.

The apparatus may be operable to communicate with the control center over a wireless communication path.

The processor, the memory, and the computer program code may be further collectively operable to cause the apparatus to create visual content of operating parameters in response to the task and provide the visual content to the control center in real-time.

The job site may be an oilfield wellsite, the field equipment may be wellsite equipment, and the visual information may represent an oilfield task for operating the wellsite equipment.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. A method of operating a communication system between a control center and a communication device proximate field equipment on a job site, comprising:
assigning a task for operating the field equipment at the control center;
creating visual information demonstrating the task;
providing the visual information to the communication device;
displaying the visual information on the communication device;
creating visual content of operating parameters of the field equipment in response to the task;
providing the visual content to the control center;
assigning an updated task for operating the field equipment in response to the visual content at the control center;
creating updated visual information demonstrating the updated task;
providing the updated visual information to the communication device; and
displaying the updated visual information on the communication device.

2. The method of claim 1 wherein the control center is remote from the job site.

3. The method of claim 1 wherein the control center is located at the job site, and wherein the method further comprises:
providing the visual content to another, offsite control center; and
assigning the updated task for operating the field equipment in response to the visual content at the control center in collaboration with the offsite control center.

4. The method of claim 1 further comprising formatting the visual information for display on the communication device.

5. The method of claim 1 further comprising monitoring the operating parameters via the visual content at the control center.

6. The method of claim 1 further comprising providing the visual information and/or the updated visual information to another communication device.

7. The method of claim 1 wherein another communication device is proximate another field equipment on the job site, and wherein the method further comprises:
assigning another task for operating the another field equipment at the control center;
creating another visual information demonstrating the another task;
providing the another visual information to the another communication device;
displaying the another visual information on the another communication device;
creating another visual content of another operating parameters of the another field equipment in response to the another task;
providing the another visual content to the control center;
assigning another updated task for operating the another field equipment in response to the another visual content at the control center;
creating another updated visual information demonstrating the another updated task;
providing the another updated visual information to the another communication device; and
displaying the another updated visual information on the another communication device.

8. The method of claim 1 wherein assigning the task and the updated task comprises a drag and drop operation on a display of a computer of the control center.

9. The method of claim 1 wherein assigning the task and the updated task comprises employing an icon and an avatar on a display of a computer of the control center.

10. The method of claim 1 wherein the visual information, the visual content, and the updated visual information comprise an image and/or a video.

11. The method of claim 1 wherein the communication device is selected from the group consisting of:
smart glasses;
a smartphone; and
a tablet computer.

12. The method of claim 1 wherein the control center and the communication device communicate over a wireless communication path.

13. The method of claim 1 wherein the method is performed in real-time.

14. The method of claim 1 wherein the job site is an oilfield wellsite, the field equipment is wellsite equipment, and the visual information represents an oilfield task for operating the wellsite equipment.

15. An apparatus operable to communicate with a communication device proximate field equipment on a job site, comprising:
a processor; and
a memory including computer program code, wherein the processor, the memory, and the computer program code are collectively operable to cause the apparatus to:
assign a task for operating the field equipment;
create visual information demonstrating the task;
provide the visual information to the communication device;
receive visual content of operating parameters of the field equipment in response to the task;
assign an updated task for operating the field equipment in response to the visual content;
create updated visual information demonstrating the updated task; and
provide the updated visual information to the communication device.

16. The apparatus of claim 15 wherein the apparatus is located at the job site, and wherein the processor, the memory, and the computer program code are further collectively operable to cause the apparatus to:
provide the visual content to an offsite control center; and
assign the updated task for operating the field equipment in response to the visual content in collaboration with the offsite control center.

17. The apparatus of claim 15 further comprising another communication device proximate another field equipment on the job site, wherein the processor, the memory, and the computer program code are further collectively operable to cause the apparatus to:
assign another task for operating the another field equipment;
create another visual information demonstrating the another task;
provide the another visual information to the another communication device;
receive another visual content of another operating parameters of the another field equipment in response to the another task;
assign an updated another task for operating the another field equipment in response to the another visual content;
create another updated visual information demonstrating the another updated task; and
provide the another updated visual information to the another communication device.

18. The apparatus of claim 15 wherein the communication device is selected from the group consisting of:
smart glasses;
a smartphone; and
a tablet computer.

19. An apparatus proximate field equipment on a job site operable to communicate with a control center, comprising:
a processor; and
a memory including computer program code, wherein the processor, the memory, and the computer program code are collectively operable to cause the apparatus to:
receive visual information for a task for operating the field equipment from the control center;
display the visual information;
create visual content of operating parameters of the field equipment in response to the task;
provide the visual content to the control center;
receive updated visual information for an updated task in response to the visual content for operating the field equipment from the control center; and
display the updated visual information.

20. The apparatus of claim 19 wherein:
the processor, the memory, and the computer program code are further collectively operable to cause the apparatus to:
format the visual information for display on the apparatus; and
cause the apparatus to create visual content of operating parameters in response to the task and provide the visual content to the control center in real-time;
the apparatus is selected from the group consisting of:
smart glasses;
a smartphone; and
a tablet computer;
the apparatus is operable to communicate with the control center over a wireless communication path; and
the job site is an oilfield wellsite, the field equipment is wellsite equipment, and the visual information represents an oilfield task for operating the wellsite equipment.
